(19) United States
(12) Patent Application Publication
(10) Pub. No.: US 2022/0082726 A1
(43) Pub. Date: Mar. 17, 2022

(54) SYSTEM AND METHOD OF CALIBRATING DOWNHOLE FIBER-OPTIC WELL MEASUREMENTS

(71) Applicant: Chevron U.S.A. Inc., San Ramon, CA (US)

(72) Inventor: Sudipta SARKAR, Houston, TX (US)

(21) Appl. No.: 17/533,445

(22) Filed: Nov. 23, 2021

Related U.S. Application Data
(63) Continuation of application No. 15/664,292, filed on Jul. 31, 2017, now abandoned.
(60) Provisional application No. 62/369,244, filed on Aug. 1, 2016.

(51) Int. Cl. G01V 13/00; G01V 1/52

(52) U.S. Cl. CPC G01V 13/00; G01V 1/226; G01V 1/52

(57) ABSTRACT

A system is described for calibrating fiber optic well measurements including a fiber optic waveguide disposed proximal to a wellbore, a sensor coupled to the fiber optic waveguide, the sensor configured to record a plurality of signals detected by the waveguide, and a computer system configured to calibrate the signals from the waveguide by filtering out one or more background acoustic responses from the plurality of signals. A method for calibrating the signals is also described.

### CROSS-REFERENCE TO RELATED APPLICATIONS

This application is a continuation of U.S. patent application Ser. No. 15/664,292 filed Jul. 31, 2017 which claims the benefit of U.S. Provisional Patent Application 62/369,244 filed Aug. 1, 2016.

### STATEMENT REGARDING FEDERALLY SPONSORED RESEARCH OR DEVELOPMENT

Not applicable.

### BACKGROUND

### Field of the Invention

This invention relates generally to the field of exploration and production for hydrocarbons. More specifically, the invention relates to a method of calibrating fiber optic measurements in wellbore environments.

### Background of the Invention

There exists a need to monitor the success and efficiency of hydraulic fracturing operations in wellbores drilled and completed in unconventional (shale or any tight rock) reservoirs. There is also a need to monitor the production from individual perforations (stages and clusters) in these wellbores. Conventional cased hole logging techniques such as production logging tool (PLT) provides measurements of the contribution to cumulative production of individual perforations at discrete times. Various production data suggest that the contributions of these individual perforations are non-steady state questioning the value of individual PLT measurements. Information about the success of individual stage/cluster perforation events can be inferred from PLT data, however, the accuracy and resolution of these data may be affected by the physical locations of the individual PLT sensors (spinners, etc.) monitoring the production, the time when the production logs are acquired, and other factors such as wellbore conditions, fluid composition, etc.

Over the past few years, fiber optic acoustic and temperature monitoring of producing petroleum wells has become a significant technology for continuously monitoring hydrocarbon and liquids production contributions as a function of position along the wellbore (vertical, deviated or horizontal). In unconventional plays, it has also become significant for characterizing individual fracking perforation events in multiple completion stages and clusters along the wellbore in vertical, deviated or horizontal wells. Fiber optic cables installed in a wellbore records sound energy traveling from acoustic sources within the formation or within the wellbore, and propagating through the in-situ wellbore environment consisting of the formation, cement, casing, casing hardware (such as centralizers, clamps, blast protectors, metallic wire ropes, etc.), attaching the fiber optic cable to the casing, and the fiber optic cable itself.

Fiber optic monitoring can continuously monitor and record the acoustic signal from completions, any downhole injection and production operations. However, in reality, this method also measures the background acoustic signals from the wellbore environment. It would be invaluable to calibrate the fiber optic cable for this background acoustic signal so that it can be removed by filtering from the total acoustic signal. Consequently, there is a need for methods and systems for calibrating fiber optic signals measured from wellbore environment for background acoustic noise.

### BRIEF SUMMARY

Embodiments of a method for calibrating fiber optic well measurements are disclosed. In general, embodiments of the method utilize measurement of sounds or events from known and/or unknown acoustic or seismic sources. In particular, embodiments of the method may use recording of activities such as without limitation, acoustic or sonic logging, surface or borehole seismic, cementing, hydraulic fracturing, water injection, hydrocarbon (oil/gas) and water production, etc. Further details and advantages of various embodiments of the method are described in more detail below.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A illustrates a schematic representation of an embodiment of the disclosed system and method as used with a wellbore disposed within a hydrocarbon reservoir;

FIG. 1B illustrates another schematic representation of an embodiment of the disclosed system and method as used when measuring a known acoustic event and/or simulated acoustic signals;

FIG. 2 illustrates a hypothetical calibration of fiber optic signals as measured from a wellbore. The top plots represent the frequency spectra measured while the bottom plots represent the amplitude spectra; and

FIG. 3 illustrates a schematic of a system which may be used in conjunction with embodiments of the disclosed methods.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

In the following discussion and in the claims, the term “production operations” may encompass any operations of well logging, fracturing, cementing, drilling, water injection, steam injection, hydrocarbon production, or combinations thereof.

### DETAILED DESCRIPTION OF THE PREFERRED EMBODIMENTS

Referring now to the Figures, embodiments of the disclosed methods will be described. As a threshold matter, embodiments of the methods may be implemented in numerous ways, as will be described in more detail below, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the disclosed methods are discussed below. The appended drawings illustrate only typical embodiments of the disclosed methods and therefore are not to be considered limiting of its scope and breadth.

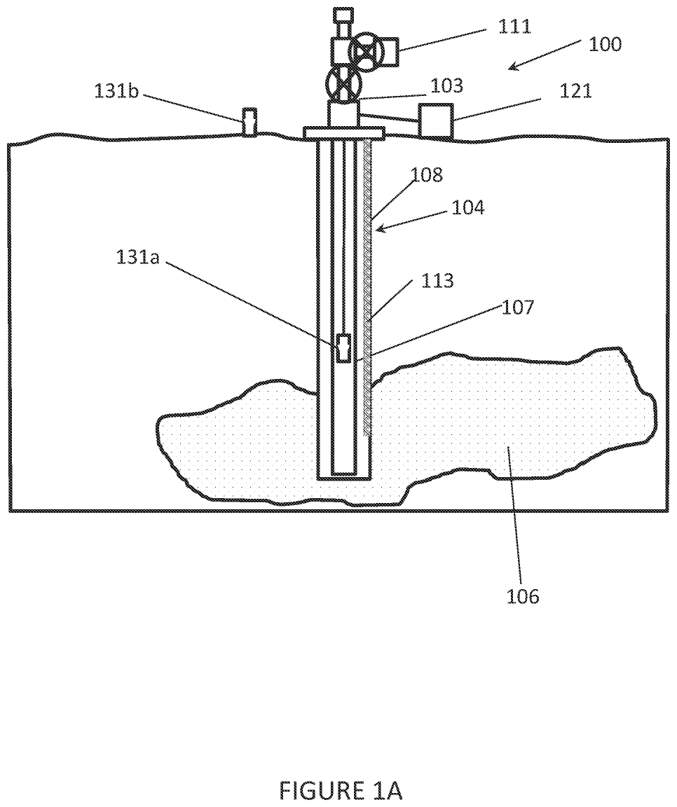

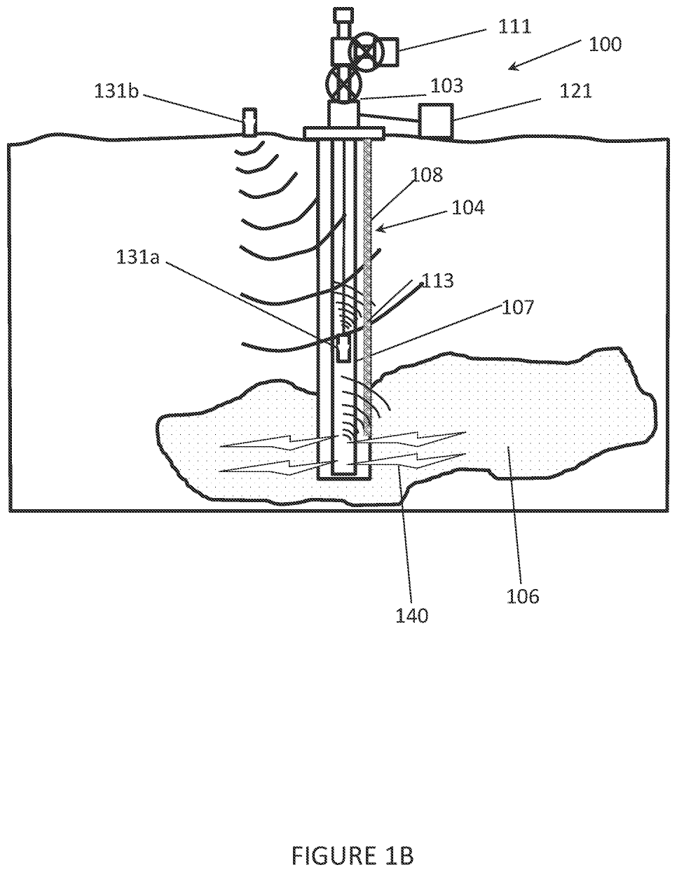

FIG. 1A illustrates an embodiment of apparatus 100 for calibrating fiber optic measurements in a wellbore or borehole 104. In the illustrated example, the wellbore 104 extends through a subterranean or subsurface hydrocarbon producing formation 106 disposed beneath the surface of the earth. Though the borehole 104 is illustrated as a straight, vertical bore, in practice the borehole 104 can have a more complex geometry (e.g. horizontal or deviated drilling) and can have any orientation, including varying orientation along its length.

The borehole 104 can be lined with a hollow casing 108 made up of a number of segments. The hollow borehole casing 108 can, for example, be configured of steel or other suitable material. In a typical drilling application, the borehole casing 108 may be a standard casing used to provide structural support to the borehole in ordinary drilling and production applications and it is not necessary to provide any additional outer conductive medium. To extract hydrocarbons from the formation 106, production tubing 107 is disposed annularly within the casing 108. The wellbore 104 may be topped with a tree 111 at the wellhead 103. Other downhole tools and devices, as are known in the art, may be included or used in conjunction with embodiments of the disclosed systems and methods. Furthermore, in an embodiment, a fiber optic waveguide (e.g. cable) 113 may be disposed in the borehole 104. As used herein, a waveguide may be any structure or device known to those of skill in the art that guides waves, such as light waves, electromagnetic waves or sound waves. In other embodiments, fiber optic waveguide 113 may be disposed within casing 108 or may be coupled to the exterior of casing 108. In other words, fiber optic waveguide may be disposed in any location within close proximity to borehole 104 so as to be able to measure signals emitted from borehole 104 or from any surroundings, which may include without limitation the formation 106, another formation, another borehole in the same or different formation, or surface. Fiber optic waveguide 113 may be any medium or device capable of transmitting optical signals along its length.

In an embodiment, a fiber optic sensor (e.g. optical sensor interrogator) 121 can be placed on the well head or in close proximity to the well head 103. However, the sensor 121 may be placed in any location suitable or sufficient such that it can sense or detect signals from fiber optic waveguide 113 from the wellbore 108. The fiber optic interrogator 121 may be any recording device or units known those of skill in the art capable of recording and/or detecting acoustic or fiber optic signals. Examples include without limitation, a distributed acoustic sensing device, a distributed temperature sensing device, and the like. In one aspect, the fiber optic interrogator 121 may passively record acoustic or seismic data from the well or the wellbore environment. In the passive mode the background noise can be recorded for a period of time. This period of time may range from hours to days. In particular, the period of time may range from about 30 minutes to about 30 days, alternatively from 6 hours to about 2 weeks, alternatively from about 24 hours to about 72 hours. The recorded data can then be processed by methods known to those of skill in the art. Examples of processing may include without limitation, deconvolution, filtering, etc.

In another aspect, as shown in FIG. 1A, an acoustic source 131a may be disposed within borehole 104 to emit acoustic signals. In another embodiment, another acoustic source 131b may be placed near or at the well head, where the acoustic source is configured to generate a periodic or continuous signal and the sensor 121 may constantly record for a period of time as discussed above. An acoustic source may also be disposed in another wellbore adjacent to the wellbore to be measured. The acoustic source 131 may be a continuous source or an impulsive source (e.g. vibrator). The acoustic sources 131a-b may be any devices known to those of a skill in the art for emitting acoustic signals. Various conventional acoustic logging tools exist that can be used to provide the acoustic source, providing a range of monopole, dipole and quadrupole transmitters, with a variety of single frequency sources and frequency sweeps roughly covering an approximate frequency range of 100 to 10 KHz. The signals detected by fiber optic waveguide 113 can then be recorded with the interrogator or detector 121. For any given well or field this procedure can be performed for every well in the field to develop a database of the records.

By way of background, the optical fiber waveguide 113 acts as a distributed acoustic sensor. Distributed optical fiber sensors operate by launching a pulse of light into an optical fiber. This generates weak scattered light which is captured by the fiber and carried back towards the source. By timing the return of this backscattered light, it is possible to accurately determine the source of the backscatter and thereby sense at all points along a fiber many tens of kilometers in length. Three different physical mechanisms produce the backscatter, being Rayleigh, Brillouin and Raman scattering. A common instrument that uses the intensity of the backscattered Rayleigh light to determine the optical loss along the fiber is known as an Optical Time Domain Reflectometer (OTDR). Rayleigh backscatter light is also used for coarse event/vibration sensing. Raman light is used by a Distributed Temperature Sensor (DTS) to measure temperature, achieving a temperature resolution of <0.01° C. and ranges of 30 km+. However the response time of distributed temperature sensors is typically a few seconds to several minutes. Distributed Brillouin based sensors have been used to measure strain and temperature and can achieve faster measurement times of 0.1 second to a few seconds with a resolution of around 10 microstrain and 0.5° C.

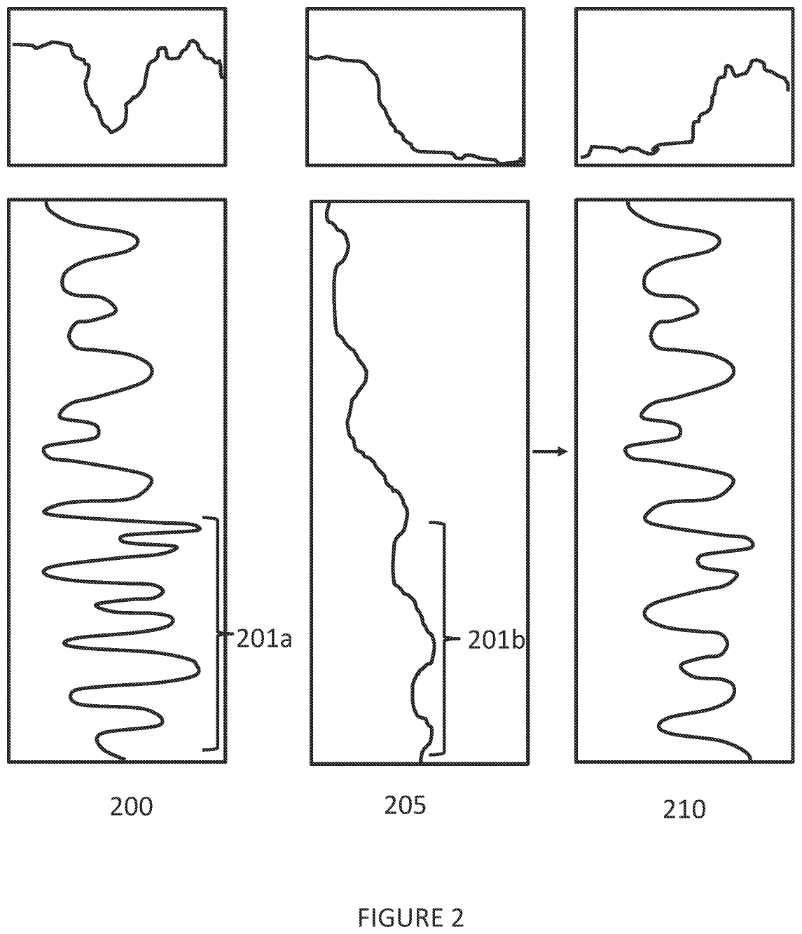

As shown in FIG. 2 a method for calibrating downhole fiber optic cable distributed acoustic sensing (DAS) data for the background acoustic response due to the in-situ borehole environment is also disclosed. The background acoustic response can be defined as the acoustic frequency and amplitude spectra responses of the fiber-optic waveguide 113 to various operations performed during exploration and production of hydrocarbons. Such operations include without limitation, seismic survey, cementing, logging, fracturing, pressure testing, water injection, flow back, production etc. Any operations known to those of skill in the art are contemplated. The responses may come from sources disposed within the borehole or external to the borehole. These data can also be recorded in an acoustically “quiet” time period, typically after cementing operations and prior to commencing hydraulic fracturing (a.k.a. fracking or frac'ing) and production operations.

In an embodiment, an acoustic source 131a can be lowered into the borehole which can be vertical, deviated or horizontal, and positioned within the casing either at a desired station depth or logged continuously over a desired depth interval.

In an embodiment, the fiber optic acoustic data (DAS) acquisition can be active during the logging operations. An acoustic source 131a can be positioned in the wellbore at the desired locations using appropriate conveyance methods (wireline, coiled tubing, tractor, etc.). In an embodiment, the acquisition sequence may be to perform stations at depths separated by an appropriate distance, 500 to 1000 ft., while tripping into the hole, and to also log continuously while pulling out of borehole 104. The time stamp of the beginning and ending of the station data is important for correlating acoustic source data with the fiber optic DAS data. Time synchronization of the source and DAS recording or interrogators systems is critical. During logging operations, depth vs. time is also useful information to have for correlation of the acoustic source data with the fiber optic DAS data. Digital waveforms for all vendor transmitter data can be used for source characterization. Alternatively, an acoustic source 131b may be disposed outside borehole 104 and the same procedures followed as described above. FIG. 1B shows schematically system 100 recording acoustic signals emitted from source 131a, source 131b, and fracturing operations 140. It is emphasized that fracking operations 140 are only used as an example and any other well or subterranean operations are contemplated in this disclosure. Although depicted for illustrative purposes as recording all of these sources simultaneously, embodiments of the method contemplate recording such signals separately, sequentially, etc.

In an embodiment, as shown in FIG. 2, processing of the fiber optic DAS data for frequency spectra and comparison with wireline source waveform frequency spectra will characterize the background signal frequency spectra for the fiber-optic cable. FIG. 2 illustrates a cartoon of the calibration process. The plots do not reflect actual data and are used for to illustrate the method only. Comparison of the fiber optic sensor response to these acoustic source stations, or to the moving acoustic source, provides an accurate determination of the fiber-optic cable's response to the in-situ environment during the acoustically quiet time period. Specifically, using acoustic logging as an example, the fiber optic response 205 is recorded with interrogator 121 and seen in waveform 205. The region 201b of waveform 205 shows the signals associated from acoustic logging operations for fiber-optic calibration. Plot 200 shows a measurement of real time data acquisition, during a subsequent subterranean operation. Thus, the region 201a shows some noise. This acoustic response 200 can be filtered from the acoustic signature 205 of the fiber-optic to other acoustic events such as those generated during a subsequent operation, e.g. during hydraulic fracturing, or production to better define the signal from the acoustic events of interest. Plot 210 shows the result of the filtered data. The filtering may be performed using any techniques know those of skill in the art including without limitation, signal processing, deconvolution, etc.

Those skilled in the art will appreciate that the disclosed methods may be practiced using any one or combination of hardware and software configurations, including but not limited to a system having single and/or multi-processor computer processors system, hand-held devices, programmable consumer electronics, mini-computers, mainframe computers, supercomputers, and the like. The disclosed methods may also be practiced in distributed computing environments where tasks are performed by servers or other processing devices that are linked through one or more data communications networks. In a distributed computing environment, program modules may be located in both local and remote computer storage media including memory storage devices.

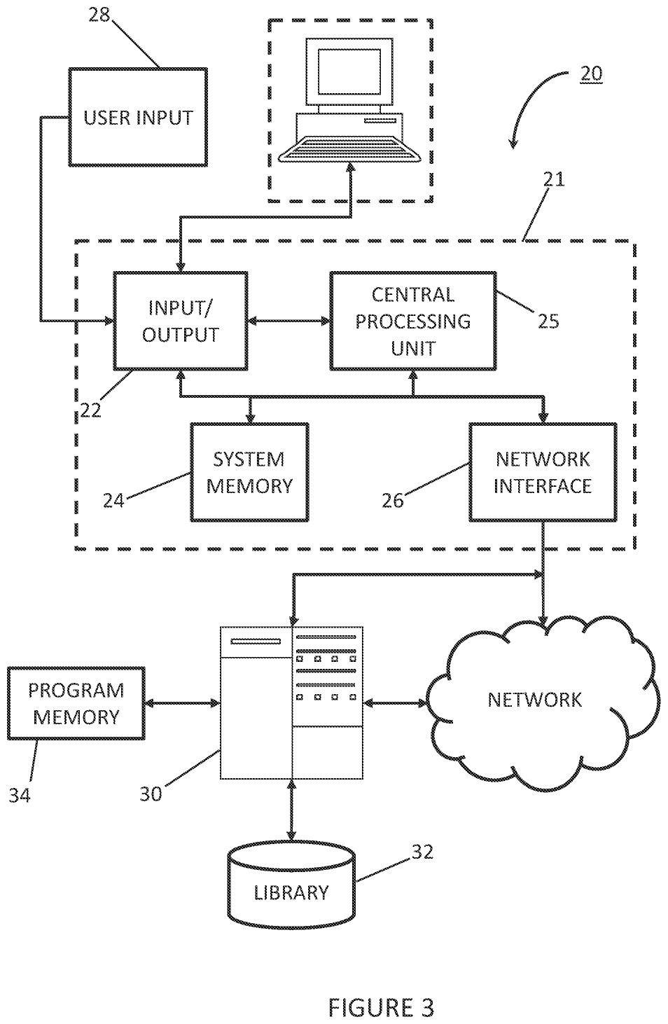

FIG. 3 illustrates, according to an example of an embodiment computer system 20, which may be used to analyze the data acquired using embodiments of the disclosed systems and methods. In this example, system 20 is as realized by way of a computer system including workstation 21 connected to server 30 by way of a network. Of course, the particular architecture and construction of a computer system useful in connection with this invention can vary widely. For example, system 20 may be realized by a single physical computer, such as a conventional workstation or personal computer, or alternatively by a computer system implemented in a distributed manner over multiple physical computers. Accordingly, the generalized architecture illustrated in FIG. 3 is provided merely by way of example.

As shown in FIG. 3 and as mentioned above, system 20 may include workstation 21 and server 30. Workstation 21 includes central processing unit 25, coupled to system bus. Also coupled to system bus is input/output interface 22, which refers to those interface resources by way of which peripheral functions P (e.g., keyboard, mouse, display, etc.) interface with the other constituents of workstation 21. Central processing unit 25 refers to the data processing capability of workstation 21, and as such may be implemented by one or more CPU cores, co-processing circuitry, and the like. The particular construction and capability of central processing unit 25 is selected according to the application needs of workstation 21, such needs including, at a minimum, the carrying out of the functions described in this specification, and also including such other functions as may be executed by computer system. In the architecture of allocation system 20 according to this example, system memory 24 is coupled to system bus, and provides memory resources of the desired type useful as data memory for storing input data and the results of processing executed by central processing unit 25, as well as program memory for storing the computer instructions to be executed by central processing unit 25 in carrying out those functions. Of course, this memory arrangement is only an example, it being understood that system memory 24 may implement such data memory and program memory in separate physical memory resources, or distributed in whole or in part outside of workstation 21. In addition, as shown in FIG. 3, acoustic or DAS data inputs 28 that are acquired from a fiber-optic survey are input via input/output function 22, and stored in a memory resource accessible to workstation 21, either locally or via network interface 26.

Network interface 26 of workstation 21 is a conventional interface or adapter by way of which workstation 21 accesses network resources on a network. As shown in FIG. 3, the network resources to which workstation 21 has access via network interface 26 includes server 30, which resides on a local area network, or a wide-area network such as an intranet, a virtual private network, or over the Internet, and which is accessible to workstation 21 by way of one of those network arrangements and by corresponding wired or wireless (or both) communication facilities. In this embodiment of the invention, server 30 is a computer system, of a conventional architecture similar, in a general sense, to that of workstation 21, and as such includes one or more central processing units, system buses, and memory resources, network interface functions, and the like. According to this embodiment of the invention, server 30 is coupled to program memory 34, which is a computer-readable medium that stores executable computer program instructions, according to which the operations described in this specification are carried out by allocation system 30. In this embodiment of the invention, these computer program instructions are executed by server 30, for example in the form of a “web-based” application, upon input data communicated from workstation 21, to create output data and results that are communicated to workstation 21 for display or output by peripherals P in a form useful to the human user of workstation 21. In addition, library 32 is also available to server 30 (and perhaps workstation 21 over the local area or wide area network), and stores such archival or reference information as may be useful in allocation system 20. Library 32 may reside on another local area network, or alternatively be accessible via the Internet or some other wide area network. It is contemplated that library 32 may also be accessible to other associated computers in the overall network.

The particular memory resource or location at which the measurements, library 32, and program memory 34 physically reside can be implemented in various locations accessible to allocation system 20. For example, these data and program instructions may be stored in local memory resources within workstation 21, within server 30, or in network-accessible memory resources to these functions. In addition, each of these data and program memory resources can itself be distributed among multiple locations. It is contemplated that those skilled in the art will be readily able to implement the storage and retrieval of the applicable measurements, models, and other information useful in connection with this embodiment of the invention, in a suitable manner for each particular application.

According to this embodiment, by way of example, system memory 24 and program memory 34 store computer instructions executable by central processing unit 25 and server 30, respectively, to carry out the disclosed operations described in this specification. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. Such computer-executable instructions may include programs, routines, objects, components, data structures, and computer software technologies that can be used to perform particular tasks and process abstract data types. It will be appreciated that the scope and underlying principles of the disclosed methods are not limited to any particular computer software technology. For example, an executable web-based application can reside at program memory 34, accessible to server 30 and client computer systems such as workstation 21, receive inputs from the client system in the form of a spreadsheet, execute algorithms modules at a web server, and provide output to the client system in some convenient display or printed form. It is contemplated that those skilled in the art having reference to this description will be readily able to realize, without undue experimentation, this embodiment of the invention in a suitable manner for the desired installations. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by allocation system 20 in the conventional manner for software installation.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A system for calibrating fiber optic well measurements, the system comprising:
a fiber optic waveguide disposed proximal to a wellbore, wherein the wellbore exists in a wellbore environment comprising of a subsurface formation traversed by the the wellbore, cement, casing, casing hardware, and the fiber optic waveguide;
a sensor coupled to the fiber optic waveguide, the sensor configured to record a plurality of acoustic signals detected by the waveguide; and
a computer system configured to calibrate the acoustic signals from the fiber optic waveguide by filtering out one or more background acoustic responses from the plurality of acoustic signals, wherein the one or more background acoustic responses are responses caused by the wellbore environment, and wherein the one or more background acoustic responses are recorded during a time period after cementing operations and prior to perforation or hydraulic fracturing.

2. The system of claim 1 further comprising an acoustic source disposed in the wellbore.

3. The system of claim 2 wherein the acoustic source comprises a logging tool.

4. The system of claim 3 wherein the acoustic source continuously generates the acoustic signals.

5. The system of claim 1 wherein the sensor comprises an optical sensor interrogator.

6. The system of claim 1 wherein the wellbore comprises a casing and the waveguide is disposed in the casing.

7. The system of claim 1 further comprising an acoustic source disposed external to the wellbore.

8. The system of claim 1 wherein the one or more background acoustic responses comprise acoustic frequency and amplitude spectra responses and the filtering is based on the acoustic frequency and amplitude spectra responses.

9. The system of claim 1 wherein the computer system comprises:
an interface for receiving a distributed acoustic dataset, the distributed acoustic dataset comprising a plurality of acoustic signals;
a memory resource;
input and output functions for presenting and receiving communication signals to and from a human user;
one or more central processing units for executing program instructions; and program memory, coupled to the central processing unit, for storing a computer program including program instructions that, when executed by the one or more central processing units, cause the computer system to perform a plurality of operations for calibrating fiber optic well measurements by filtering out background acoustic responses from one or more production operations wherein the background acoustic responses are recorded during a time period after cementing operations and prior to perforation or hydraulic fracturing wherein the one or more background acoustic responses comprise acoustic frequency and amplitude spectra responses.

10. The system of claim 9 wherein the production operations comprises one of well logging, fracturing, drilling, water injection steam injection, hydrocarbon production, or combinations thereof.

11. The system of claim 9 wherein the filtering comprises deconvolution, signal processing, or combinations thereof, based on the acoustic frequency and amplitude spectra responses.

12. A method of calibrating fiber optic well measurements, the method comprising:
(a) recording one or more background acoustic responses using a fiber optic waveguide and an interrogator device disposed proximate a wellbore, wherein the wellbore exists in a wellbore environment comprising of a subsurface formation traversed by the wellbore, cement, casing, casing hardware, and the fiber optic waveguide, the background acoustic responses being representative of one or more production operations, wherein the background acoustic responses are responses caused by the wellbore environment;
(b) recording a monitoring dataset comprising a plurality of acoustic signals from the wellbore for a period of time using the waveguide and the interrogator device; and
(c) calibrating the monitoring dataset by filtering out the one or more background acoustic responses from the monitoring dataset wherein the one or more background acoustic responses are recorded during a time period after cementing operations and prior to perforation or hydraulic fracturing and wherein the one or more background acoustic responses comprise acoustic frequency and amplitude spectra responses.

13. The method of claim 12 wherein the period of time ranges from 30 minutes to 30 days.

14. The method of claim 12 wherein (a) comprises inserting an acoustic source into the wellbore and recording the background acoustic responses emitted from the acoustic source.

15. The method of claim 14 wherein the acoustic source is a logging tool.

16. The method of claim 14 further comprising recording the background acoustic responses at a plurality of depths.

17. The method of claim 12 wherein (a) comprises using an acoustic source external to the wellbore and recording the background acoustic responses emitted from the acoustic source.

18. The method of claim 12 wherein (c) comprises filtering out the one or more background acoustic responses from the monitoring dataset by deconvolution and signal processing, or combinations thereof, based on the acoustic frequency and amplitude spectra responses.

19. The method of claim 12 wherein the one or more production operations comprises one of well logging, fracturing, drilling, water injection, or combinations thereof.

20. A method of calibrating fiber optic well measurements, the method comprising:
(a) generating a plurality of background acoustic signals using an acoustic source disposed in at least one wellbore, wherein the at least one wellbore exists in a wellbore environment comprising of a subsurface formation traversed by the wellbore, cement, casing, casing hardware, and the fiber optic waveguide, wherein the plurality of background acoustic signals are representative of one or more production operations and the plurality of background acoustic responses are responses caused by the wellbore environment, and wherein the plurality of background acoustic responses are recorded during a time period after cementing operations and prior to perforation or hydraulic fracturing and wherein the one or more background acoustic responses comprise acoustic frequency and amplitude spectra responses;
(b) recording acoustic signals from the wellbores using a fiber optic waveguide proximate the wellbores to get one or more real-time fiber optic well measurements; and
(c) filtering the plurality of background acoustic signals from the one or more real-time fiber optic well measurements based on the acoustic frequency and amplitude spectra responses to calibrate the fiber optic well measurements.
